(19) United States
(12) Patent Application Publication
(10) Pub. No.: US 2006/0207234 A1
(43) Pub. Date: Sep. 21, 2006

(54) Coalescing filter elements comprising self-sustaining, bonded fiber structures

(76) Inventors: Bennett C. Ward, Midlothian, VA (US); Jian Xiang, Midlothian, VA (US); Thomas E. Harris JR., Colonial Heights, VA (US); Ronald J. Binshtok, Richmond, VA (US)

Correspondence Address: HUNTON & WILLIAMS LLP;Riverfront Plaza, East Tower, 951 E. Byrd Street, Richmond, VA, 23219-4074, US

(21) Appl. No.: 11/377,071

(22) Filed: Mar. 15, 2006

Related U.S. Application Data
(60) Provisional application No. 60/663,126, filed on Mar. 18, 2005.

(51) Int. Cl. B01D 39/14

(52) U.S. Cl. 55/524

(57) ABSTRACT

Filter elements are provided for removing a liquid challenge material dispersed in a carrier fluid. The filter element comprises a three dimensional, self-sustaining, fluid transmissive body comprising a plurality of thermoplastic fibers bonded to each other at spaced apart points of contact. The fibers collectively define a tortuous fluid flow path through the fluid transmissive body from a fluid inlet surface to a fluid outlet surface. At least a portion of the thermoplastic fibers comprise a surface-forming material having a surface energy that is less than a surface tension of the challenge material.

This application claims priority to U.S. Provisional Application No. 60/663,126, filed Mar. 18, 2005, which is incorporated herein by reference in its entirety.

### BACKGROUND

The present invention relates generally to the field of filtration devices and, more particularly, to oil and/or water coalescing filters comprising three dimensional, self-sustaining, bonded fiber structure structures.

In 2004, the U.S. Environmental Protection Agency (EPA) issued a regulation effective 2007-2010 for reducing toxic particulates and pollution from heavy and medium duty diesel engines (class 4 and above, on- and off-road applications). This regulation is designed to cut diesel emissions of carbon residue (“soot”) by 90% and nitrogen oxide emissions by 95%.

Crankcase blow-by gases are considered a major source of toxic particulate matter (PM) emissions. Most medium and heavy duty diesel engines operated today in North America vent combustive aerosols into the atmosphere through a tube. The emitted blow-by combustive aerosols consist mainly of oil droplets, with some soot.

To comply with the proposed EPA regulations, heavy duty engine and vehicle manufacturers have come up with several approaches to reduce emissions. These approaches include advanced engine designs, advanced integrated emission control technology and high quality fuel.

Employment of oil coalescing filters is one of the key elements for engine emission control. While various oil coalescing filters have been produced, they have either been lacking in performance or too costly to be an effective solution to the problem.

### SUMMARY OF THE INVENTION

Embodiments of the present invention provide coalescing filter elements that may be used to remove oil, water and/or other liquids (“challenge materials”) from a carrier fluid stream. An illustrative aspect of the invention provides a filter element for removing a liquid challenge material dispersed in a carrier fluid. The filter element comprises a three dimensional, self-sustaining, fluid transmissive body comprising a plurality of thermoplastic fibers bonded to each other at spaced apart points of contact. The fibers collectively define a tortuous fluid flow path through the fluid transmissive body from a fluid inlet surface to a fluid outlet surface. At least a portion of the thermoplastic fibers comprise a surface-forming material having a surface energy that is less than a surface tension of the challenge material.

### BRIEF DESCRIPTION OF THE DRAWINGS

In order to assist in the understanding of the invention, reference will now be made to the appended drawings, in which like reference characters refer to like elements. The drawings are exemplary only, and should not be construed as limiting the invention.

FIG. 1 is a perspective view of a challenge material coalescing filter according to an embodiment of the invention;

FIG. 2 is a perspective view of a cylindrical challenge material coalescing filter according to an embodiment of the invention;

FIG. 3 is a cross-sectional view of a cylindrical challenge material coalescing filter according to an embodiment of the invention;

FIG. 4 is a cross-sectional view of a cylindrical challenge material coalescing filter according to an embodiment of the invention;

FIG. 5 is a cross-sectional view of an anisotropic challenge material coalescing filter according to an embodiment of the invention;

FIG. 6 is a cross-sectional view of a cylindrical anisotropic challenge material coalescing filter according to an embodiment of the invention;

FIG. 7 is a photograph of fluorochemically treated and untreated bonded fiber structures;

FIG. 8 is a photograph of fluorochemically treated and untreated bonded fiber structures;

FIG. 9 is a photograph of individual fluorochemically treated fibers; and

FIG. 10 is a photograph of individual fluorochemically treated fibers after long-term exposure to oil.

### DETAILED DESCRIPTION OF THE INVENTION

Embodiments of the present invention provide coalescing filter elements that may be used to remove oil, water and/or other liquids (“challenge materials”) from a carrier fluid stream. Although the examples discussed herein relate primarily to removal of liquid aerosols from gaseous fluid streams, it will be understood that filter embodiments of the invention may be adapted for use in applications where the carrier fluid is a liquid and/or the challenge material is present in the stream in non-aerosol form.

Approaches to coalescing filters to date have consisted primarily of mechanical centrifugal separators and passive filters formed from a variety of materials. Both approaches have significant drawbacks. Mechanical separation is complex, expensive and requires power to drive the separator. More importantly, it does not meet stringent efficiency requirements.

Passive coalescing filters operate by passing a carrier fluid and a challenge material through a filter medium that impedes the passage of challenge material droplets. The filter medium is typically treated so that the challenge material droplets coalesce with other droplets to form larger droplets, which may be gravitationally separated from the carrier fluid. If the density of the droplets is greater than that of the fluid (e.g., oil droplets in air), the droplets will tend to sink to the bottom of the filter element. If the density of the droplets is less than that of the fluid (e.g., oil droplets in water), the droplets will tend to rise to the top of the filter element.

Passive oil coalescing filters are typically formed from paper or non-woven sheet stock comprising man-made fibers such as polyester. The sheet stock is often chemically treated or coated so as to present an oleophobic and/or hydrophobic surface. The sheet stock is then pleated to form a shape that can be used as an oil coalescing device. Often the pleated filter stock is rolled to form a cylindrical filter element.

The resulting filters typically have significant performance problems. In general, pleated non-wovens are subject to plugging (or blinding) by retained soot, have difficulty meeting efficiency requirements, and are expensive due to the additional processes required to conduct the pleating and assembly operations. Typical nonwoven paper filters have filtration efficiencies of less than 85% with life expectancies below 500 hours.

One of the most significant factors limiting the performance of prior art passive filters is the inherent limit on the surface area available for coalescing material droplets. Even with pleating or specific performance enhancing geometries, the performance of these types of filter elements is unlikely to meet rising removal standards.

Embodiments of the present invention provide coalescing filter elements comprising self-sustaining, bonded fiber structures that provide significantly higher surface areas for coalescing challenge materials. The high surface area allows the design of a filter element with a greater void volume for a given porosity than can be achieved with conventional filter media. The result is that the filter materials of the invention provide high separation efficiency and longer life.

The bonded fiber structures of the invention are typically three-dimensional porous elements formed from a web of thermoplastic fibrous material. The resulting material may be made up of an interconnecting network of highly dispersed continuous (e.g., filament) and/or discontinuous (e.g., staple) fibers bonded to each other at various points of contact to provide a series of tortuous fluid paths with very high surface areas. As will be discussed, a given fiber structure may be formed to provide uniform characteristics throughout or may be formed with discrete regions having different structural or material characteristics.

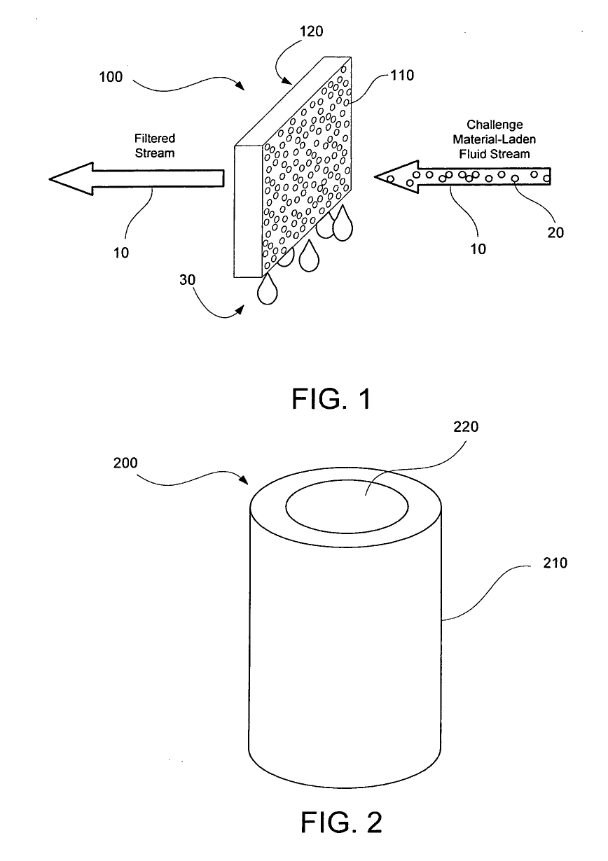

The fibrous materials of the bonded fiber structures of the invention may be tailored to have surface energies below the surface tension of a particular challenge material such as a liquid aerosol or mist. This causes the challenge material to coalesce on the surfaces defining the tortuous fluid paths through the structure. As shown in FIG. 1, challenge material droplets 20 are passed into the bonded fiber filter element 100 with the carrier fluid 10 through the upstream or challenge-side surface 110 of the filter element 100. In order to pass through the filter element 100, the fluid 10 must negotiate the tortuous path through the bonded fiber network. The challenge material droplets 20, tend to be unable to follow the fluid 10 through this network and, as a result impinge on the fiber surfaces bounding the tortuous fluid paths. By virtue of the tailoring of the material at the surface of some or all of the bonded fibers, the challenge material droplets bead up and coalesce. If the specific gravity of the challenge material is greater than that of the carrier fluid, the coalesced droplets eventually become heavy enough to drain from the bottom of the filter element 100, allowing them to be collected and, if desired, recycled. If, on the other hand, the specific gravity of the challenge material is less than that of the carrier fluid, the coalesced droplets will rise to the top of the filter element 100 where they can be separated from the carrier fluid.

The filter element 100 may be formed as a monolithic block, sheet or slab. It may be configured and positioned so that gravity acts to draw a coalesced challenge material in a direction roughly orthogonal to the flow direction. It will be understood, however, that the invention is not restricted to such a configuration. For example, the filter element 100 may be positioned so that gravity acts in a direction directly opposed to the flow direction of the carrier fluid or in any other direction. It will also be understood that although it is illustrated with a rectangular cross-section, the filter element 100 may be formed with any regular or irregular cross-sectional shape and may be provided with virtually any thickness.

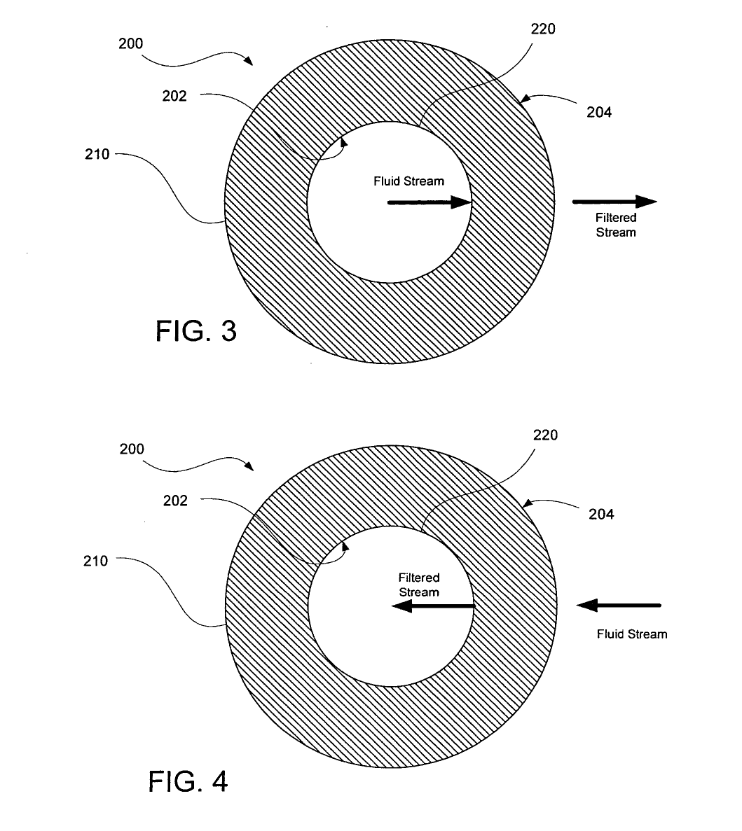

The filter elements of the invention are not limited to monolithic structures, but instead may be provided in a wide variety of shapes and configurations. With reference to FIGS. 2-4, a filter element 200 of the invention may be formed, for example, as an annular cylindrical body 210 having a cylindrical center perforation 220. Although both the inner surface 202 and outer surface 204 are shown as circular cylindrical surfaces, it will be understood that either surface may be formed with a non-circular (e.g., elliptical, polygonal or irregular) cross-section. In some embodiments, a cylindrical element may have multiple cylindrical perforations.

As shown in the cross-sectional views of the filter element 200 depicted in FIGS. 3 and 4, a fluid to be filtered may be passed radially outward through the fibrous structure (i.e., from the interior surface 202 toward the exterior surface 204) or radially inward (i.e., from the exterior surface 204 inward toward the interior surface 202).

Bonded fiber filter elements according to embodiments of the invention may be formed so that they have substantially the same characteristics throughout the structure. Some bonded fiber filter elements, however, may be formed with different regions having different characteristics. Each region may be formed, for example, with different fiber materials or with different structural characteristics such as density and porosity. Different regions may also be formed with different fiber surface energy characteristics. Formation of such anisotropic bonded fiber structures may be accomplished, for example, using the methods described in co-pending U.S. application Ser. No. 11/333,499, filed Jan. 17, 2006, which is incorporated herein by reference in its entirety.

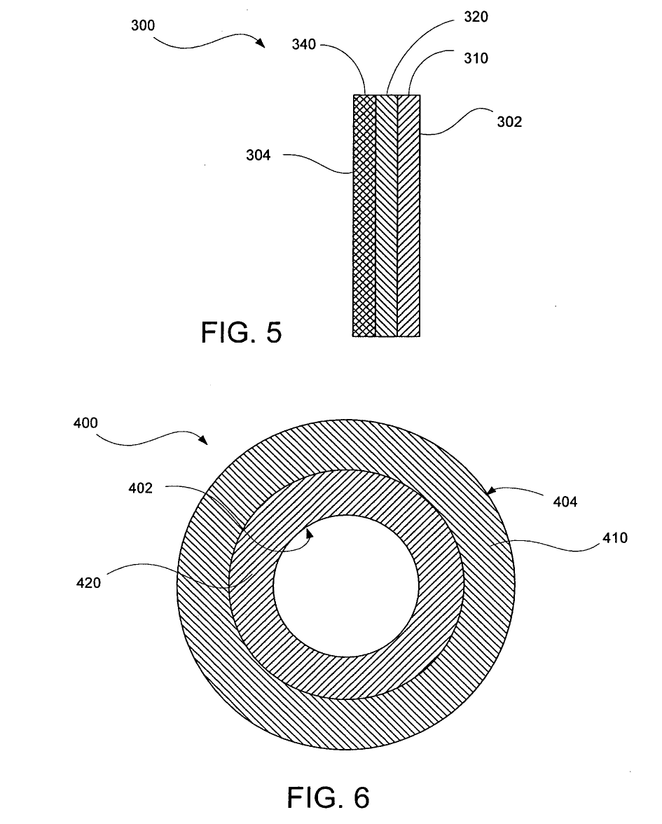

FIG. 5 illustrates an exemplary anisotropic filter element 300 formed as a bonded fiber structure having three distinct regions 310, 320, 330. The first region 310 provides a fluid inlet surface 302 through which a challenge material-laden carrier fluid may be passed into the filter element 300. The third region 330 provides a fluid outlet surface 304 through which the filtered carrier fluid may be passed. The second region 320 is disposed intermediate the first and third regions 310, 330. The regions 310, 320, 330 anisotropic filter element 300 may be configured to provide a sequence of differing filtration and/or material coalescing characteristics. Thus, each region may have its own combination of density, porosity, surface area, void volume and fiber material characteristics.

In some embodiments, for example, the structure of the three regions 310, 320, 330 may be tailored so that the porosity of the filter element decreases as a fluid passes from the inlet surface 302 to the outlet surface 304. This may be accomplished by forming the first region 310 with a first average pore size, the second region 320 with a second average pore size that is lower than the first, and the third region 330 with a third average pore size that is lower than the second. The result is a particularly effective depth filter element.

In addition to or instead of porosity variations, the three regions 310, 320, 330 may have different fiber material characteristics. In some particular embodiments, the fiber structure of each region may be tailored—or comprise materials that are tailored—to have different surface energy characteristics so that each region may have different material coalescing properties.

It will be understood that while the anisotropic filter element 300 is shown with three regions, such filter elements may be formed with any number of regions. This provides the capability of tailoring the filter elements characteristics to a wide range of performance requirements. In a particular application, for example, a filter element may be formed with a large number of regions to provide a complex porosity gradient through the filter element.

As with the single-region filter elements described above, anisotropic filter elements of the invention may be configured in a wide variety of shapes and configurations. FIG. 6, for example, illustrates a cylindrical filter element 400 according to an embodiment of the invention that comprises a bonded fiber structure having two cross-sectional regions 410, 420 that may have different fiber, structural or other characteristics. For example, the inner fiber structure region 420 may have a structure that provides a first combination of density, porosity, surface area and void volume, while the outer fiber structure 410 provides a second combination of density, porosity, surface area and void volume. In another example, the inner fiber structure region may be adapted so that the surface of the fibrous network in this region has one surface energy while the outer fiber structure is adapted so that the surface area in that region has a second surface energy. Again, it will be understood that such filter elements may be formed with any number of regions.

The fibrous network of the bonded fiber structures of the invention may be formed from any of a variety of fiber types including extruded fibers, monocomponent fibers, bicomponent fibers, melt-blown fibers, wet-spun fibers, dry-spun fibers, bonded fibers, and the like. The composition of the fibers may include any thermoplastic or thermoset polymeric material, including but not limited to, cellulose acetate, other acetates and esters of cellulose, virgin or regenerated cellulose, polyamides, such as nylons, including nylon 6 and nylon 66; polyolefins, such as polyethylene and polypropylene; polyesters including polyethylene terephthalate and polybutylene terephthalate; polyvinyl chloride; polymers of ethylene methacrylic acid, ethylene acrylic acid, ethylene vinyl acetate, or ethylene methyl acrylate; polystyrene; polysulfones; polyphenylene sulfide; polyacetals; acrylics and polymers comprising blocks of polyethylene glycol; as well as copolymers and derivatives of all of the foregoing.

The fibrous network may also be formed from or include inorganic fibers formed from glass or ceramics. In particular embodiments, the fibrous network may be formed from a combination of bondable organic fibrous materials interspersed with inorganic fiber materials.

The fibrous network may be formed from a single fiber type (that is, all of the fibers comprise substantially the same component geometry and materials) or from a combination of fibers of different types, materials and/or configurations. For example, the fibrous network may be formed from bimodal webs such as those described in U.S. Pat. No. 6,103,181, which is incorporated herein by reference in its entirety. In some embodiments, the fibrous network may be formed from a combination in which some fibers have surfaces tailored to coalesce a certain challenge material and other fibers that are not tailored. In some embodiments, some of the fibers may be tailored for one challenge material, while other fibers are tailored for another.

The composition of the fibers used in a particular filter product may be selected based on its intended use. For example, for an oil coalescing application, one would typically use a fiber system that is not chemically affected by oil, hydrocarbons, or fluids used typically in automotive or transportation applications. Exemplary fibers that are compatible with such applications include but are not limited to cellulose acetate, polyester, nylon, and highly crystalline polypropylene.

The fibers used to form filter elements of the invention may be monocomponent or multicomponent fibers. As used herein, the term “multicomponent” refers to a fiber having two or more distinct components integrally formed from polymer materials having different characteristics and/or a different chemical nature. Bicomponent fibers are multicomponent fibers that have two distinct polymer components. It will be understood by those of ordinary skill in the art that the integrally formed polymer components of multicomponent fibers are distinguishable from coatings or material layers that may be adhered to a fiber after it has been extruded or spun.

In particular embodiments of the invention, the fibrous network may comprise sheath-core multicomponent fibers having a sheath of polyethylene, polypropylene, or copolymers thereof, polyester (including polyethylene terephthalate (PET) or copolymers thereof), nylon 6 (or other polyamides), polystyrene, polycarbonate, polyarylate, ionomers, and numerous-other polymers. The core of these fibers may comprise crystalline or semi-crystalline polymers, including, but not limited to PET, polybutylene terephthalate (PBT), polypropylene, nylon 6, or nylon 66. As will be discussed, the fiber sheath may comprise a particular material (e.g., a fluorochemical) in order to tailor the surface energy of the fiber.

Any of the above-described fiber materials may be used to form bonded fiber structures that may be employed as coalescing filter elements according to various embodiments of the invention. These bonded fiber structures may be formed using any of a variety of forming methods depending on the nature and form of the fibers being used and the desired properties of the final structure. The fiber material input to the forming process may be in the form of bundled individual filaments, tows, roving, webs or lightly bonded non-woven sheets. The fibers may be mechanically crimped or may be structured so that self-crimping may be induced (e.g., by stretching and then relaxing the fibers) during the continuous forming process. The fibers may also be melt blown or formed by a spun bond process.

In particular embodiments, the fibers used to form filter elements according to embodiments of the invention may be provided in the form of:
Bundled individual multicomponent filaments, which may be crimped prior to forming to enhance entanglement and heterogeneity of the fiber network;
Bundled individual sheath/core bicomponent filaments, where the sheath/core arrangement is acentric (thereby making them self crimping), which may be stretched and/or relaxed to induce crimp prior to forming;
Tows of multicomponent fibers, which may be crimped prior to forming;
Tows of monocomponent fibers, which may be crimped and treated with plasticizer prior to forming.
Multicomponent staple fibers, processed into a roving or lightly bonded non-woven sheet;
Monocomponent staple fibers, treated with plasticizer and processed into a roving or lightly bonded non-woven sheet prior to forming;
Webs of melt spun or melt blown multicomponent fibers; and
Bimodal webs of melt blown fibers.

The above fiber materials may be formed into bonded fiber structures using any of several continuous bonding processes. A typical forming process for use with fiber materials comprising a bondable fiber component involves drawing the fiber materials through a heating zone to soften or melt the bondable material. The heating zone may include any of various mechanisms for heating the fiber material to a desired temperature, typically a temperature in excess of the melt or softening temperature of at least one fiber component to facilitate bonding of the fibers at their points of contact with one another. The heating mechanism of the heating zone may include, for example, sources of radiant heat, hot air, or steam. The heating mechanism may include an oven or, in some embodiments, a heated die that not only serves as a heating mechanism, but also forces the fiber material to adopt a predetermined cross-section. Once the bonds have been established, the fiber material may be passed through a cooling zone to set the bonds established in the heating zone, thereby producing a self-sustaining bonded fiber structure.

As described in U.S. Pat. Nos. 5,620,641; 5,633,082; 6,103,181; 6,330,883; and 6,840,692, each of which is incorporated herein by reference in its entirety, bonded fiber structures formed using the above methods can be produced in a variety of sizes and shapes. This generally means that the final cross-sectional shape of the filter element can be achieved as the direct output of the forming process, even if the shape is relatively complex. No further processing or cutting (other than cutting to length) is required.

Some bonded fiber structures of the invention may be formed using a plasticizer-aided bonding process, such as that disclosed in U.S. Pat. Nos. 3,533,416; 3,599,646; 3,637,447; and 3,703,429, which are incorporated herein by reference in their entirety. This process utilizes tows of fibers (such as cellulose acetate or nylon), which, when treated with a plasticizer, may be impinged in a forming die with air pressure and then treated with steam to form a porous, three dimensional, self sustaining, bonded fiber structure.

As described in co-pending U.S. application Ser. No. 11/333,499, variations on the above manufacturing processes may be used to produce anisotropic filter elements having cross-sectional regions with different structural or fiber material characteristics.

The above processing methods produce fluid transmissive, self-sustaining, bonded fiber structures. These structures have a highly complex network of bonded fibers that collectively form tortuous flow paths through the structure. The multiplicity of fibers surrounding these tortuous flow paths provide a large surface area for impingement of challenge material droplets. The surface energy of some or all of this surface area can be tailored so that the challenge material droplets are repelled. This causes the droplets to bead and coalesce to form larger droplets.

The surface energy of the fiber surfaces can be tailored in several ways, including by treating the final fiber structure with materials for coating exposed surfaces, treating the constituent fibers prior to formation of the bonded structure, or forming the constituent fibers using a material that provides a desired surface energy. The tailored surfaces may be adapted to repel oil, water and most other solvents.

It will be understood that, absent deliberate surface energy tailoring, the surface energy of standard bonded fiber structural materials will be higher than the surface tension of the challenge materials to be removed. For example, the surface energies of conventional bonded fiber structural elements are typically 30 dyne/cm or higher. When hydrocarbon-based oils or other challenge materials having surface tensions at or below 30 dynes/cm contact the fiber elements, the challenge material tends to “wet out” the fiber surface, thereby allowing the challenge material to easily penetrate inside the structure.

In the filter elements of the present invention, this problem is avoided by tailoring the surfaces of some or all of the fiber elements of the bonded fiber structure so that their surface energies are lower than the surface tension of the challenge material to be removed from the carrier stream. For example, in an oil coalescing filter element, the bonded fiber components may be made more oleophobic (oil repellant) by adapting the fibers so that the fluid paths through the structure are at least partially bounded by a low surface energy material. This may be accomplished in several ways. First, a low surface energy structure may be produced by forming the constituent fibers, at least in part, from low surface energy materials. For multicomponent fibers, this may be accomplished by forming at least one of the fiber components from a low surface energy material such as, for example, a thermoplastic fluoropolymer. As an alternative, an additive may be compounded into a polymer used to form one or more components of the fiber. In sheath-core fibers, the low surface energy material would be used to form the sheath component. In side-by-side multicomponent fibers, any or all of the fiber components may be comprise such a material

As an alternative to forming the fibers with a low surface energy material, already formed fiber components may be subsequently coated with a low surface energy material. This coating may be applied to the fibers prior to forming the bonded fiber structure or may be applied during or after formation of the bonded structure.

These tailoring methodologies will now be described in more detail. While the following description uses examples directed to oil coalescing filters, it will be understood that the methods described apply to other applications as well. In general, tailoring a fiber structure for an oil coalescing filter entails making the fibers more oleophobic. This may be accomplished through the application of fluorochemicals or other chemicals whose surface energies are lower than oils. Fluorochemicals or fluoropolymers typically have surface energies in the range of 12-20 dyne/cm. Silicone polymers, which typically have surface energies of 20-26 dyne/cm, may also be used.

As noted above, fluorochemicals (and other chemicals) may be introduced or applied in several ways. In some embodiments, fully formed, bonded fiber filter elements may be treated with a fluorochemical finish or coating. Suitable fluorochemical materials may include fluoroacrylate copolymers, perfluoroacrylate copolymers, fluoroalkylacrylate copolymers, fluoroalkylmethacrylate copolymers, fluoroalkyl alcohols, fluoroalkyl esters, fluoro-substituted olefin copolymers, which are produced by DuPont®, Diakin Americas®, and other suppliers. These materials are typically provided as water-based emulsions. The bonded fiber filter element may be treated with the fluorochemical material, either by immersion or by spraying, so that the entire filter element is saturated with liquid. The filter may then be dewatered (for example, by centrifugation), then dried in an oven, to remove any remaining water and leave a fluorochemical residue on the fiber surface. The filter may then be heated to a temperature of between 100° C. and 170° C. for about 5-25 minutes to allow the residual fluorochemical to evenly coat the fiber surface, creating a durable, oleophobic film.

It will be understood by those of ordinary skill in the art that the above-described post-formation treatment of the bonded fiber elements of the invention may be accomplished as part of the continuous formation processes described above or it may be accomplished in a separate process. It will also be understood that the post-formation approach tends to produce a fluorochemical-coating throughout the entire bonded fiber structure.

As an alternative to post-formation treatment, some or all of the fibers used to produce the bonded fiber structure may be treated with a fluorochemical finish before they are shaped and bonded to form the three dimensional filter element. This may be accomplished by immersing or spraying the fiber materials (in the form of, for example, webs or tows) prior to their introduction into the forming process. The fluorochemical material may be dried and cured to form a coating on the fiber surfaces prior to introduction into the forming process. Alternatively, the emulsion coated fibers may be introduced into the forming process without curing the fluorochemical finish. In this case, the fluorochemical coating is cured after the fibers are formed into the filter element.

It can be seen that treatment of fiber materials prior to formation may allow the processor to treat some fiber materials while leaving other materials untreated, or to apply different treatments to different fiber materials. This allows the tailoring of the coalescing characteristics of the final bonded fiber structure. This may be of particular significance in the case of anisotropic filter elements where some fiber regions may be treated to have desired coalescing characteristics while other regions are treated to have different characteristics, or are left untreated.

Another approach that allows tailoring of the coalescing characteristics of a bonded fiber structure is to introduce an additive into a constituent polymer of one or more of the fibers used to form the bonded fiber structure. Such an additive may be compounded into a surface component polymer before the fibers are spun. For example, a fluorochemical-based additive may be compounded with a polyester to form a monocomponent fiber or sheath component of a sheath-core multicomponent fiber. A particular fiber web used to form the bonded fiber structure may use these materials alone or in combination with other fibers (e.g., as a bimodal fiber web). The resulting bonded fiber structure will therefore comprise fibers having a surface energy tailored by the additive material. For example, a bonded fiber structure comprising fibers with a surface-forming (i.e., outermost) component including a fluorochemical-based additive will exhibit oleophobic surface characteristics.

In a similar tailoring approach, constituent fibers may be formed with a surface-forming component formed from a base thermoplastic polymer that inherently provides a particular surface energy. -For example, a multicomponent fiber may be formed with at least one component comprising a thermoplastic fluoropolymer, such as polyvinylidene fluoride, ethylene-chlorotrifluoroethylene copolymer, polychlorotrifluoroethylene, fluorinated ethylene propylene copolymer, perfluoroalkoxy polymers, copolymers of tetrafluoroethylene and perfluormethylvinyl ether, copolymers of tetrafluoroethylene and perfluoroalkyl vinyl ester, copolymers of tetrafluoroethylene and hexafluoropropylene, copolymers of tetrafluoroethylene and ethylene, copolymers of vinylidene fluoride and hexafluoropropylene, terpolymers of vinylidene fluoride, hexafluoropropylene and trifluoroethylene, polytrifluoroethylene, and polyhexafluoropropylene. In particular embodiments, a bonded fiber structure may be formed from a sheath-core bicomponent fiber in which the sheath is formed from a thermoplastic fluoropolymer.

Tailoring or selecting the surface-forming components of constituent fibers allows the tailoring of the coalescing characteristics of the bonded fiber structure and, in particular, different regions of an anisotropic structure. It can be seen that some regions of such a structure may comprise fibers having tailored surface-forming components while others do not. Additionally, different regions of a bonded fiber structure may comprise fibers having surface-forming components tailored with different materials.

It will be understood that in each of the above-described embodiments, the final bonded fiber structure comprises fibers, at least a portion of which, have a surface-forming material that is selected or tailored to provide a predetermined surface energy. In some embodiments, the surface-forming material is a coating applied to the fibers in either their bonded or unbonded form. In other embodiments, the surface-forming material is comprised by an integrally-formed component of the fiber itself.

While the above examples relate primarily to oil coalescing materials, it will be understood that the embodiments described may be adapted to water (or other solvent) coalescing filters by replacing the fluorochemical materials with, for example, silicone-based materials. Silicone coatings typically have surface energies in the range of 20-26 dyne/cm, which may coalesce water and more polar liquids, but may not be low enough to coalesce oils or hydrocarbons. Water coalescing filter elements according to the invention may be used to remove water from fluids such as oil aerosols, fuel water mixtures, natural gas, etc.

### EXAMPLE

Exemplary filter elements according to an embodiment of the invention were produced using cellulose acetate fibers. These filter elements were produced using one or more tow ribbons comprising 1.6 dpf cellulose acetate fibers. The two ribbons were drawn between feeding rolls and drawing rolls at a ratio of 1.2-2. In the drawing section, the tow fibers were separated and crimpled so that the fibers would be bonded more uniformly later in the process. After drawing, 10% triacetin (weight % vs. weight of fiber), a plasticizer, was applied on the crimped fibers via dipping and spraying techniques. The fibers were then sent into a forming zone where they were softened and bonded to each other at points of contact to form a continuous three dimensional bonded fiber structure. This bonded structure was then cut in to specified filter element lengths.

Some of the cut filter elements were then treated with 4% w/v Repearl F-7005 (fluoroacrylate copolymer emulsion) along with 0.8% w/v Repearl MF (crosslinking reagent), both supplied by Mitsubishi (MIC) Specialty Chemicals, by soaking at room temperature for about 15 minutes. After being dried in a convection oven at 60° C. overnight, the filters were cured at 160° C. for about 10 minutes in a convection oven. Some of the treated filters were dissected to assure that complete fiber coating was achieved throughout the bonded fiber structure. The final porosities (i.e., ratios of void volume to overall volume) of the filter elements were between 80-92%. The treated filters were thermally stable to at least 120° C. to 140° C. and were chemically compatible with oil mist.

The fluorochemical—treated filters were tested for oil mist retention efficiency and capacity by InterBasic Resource Inc (Grass Lake, Mich.) using a method in accordance with Compressed Air and Gas Institute (CAGI) ADF 400. The filters were impinged with SAE 15W-40 oil in aerosol form at room temperature with a flow rate of 5 SCFM until a predefined saturation point was reached. The filter elements in the above-stated porosity range demonstrated greater than 99% coalescing efficiency.

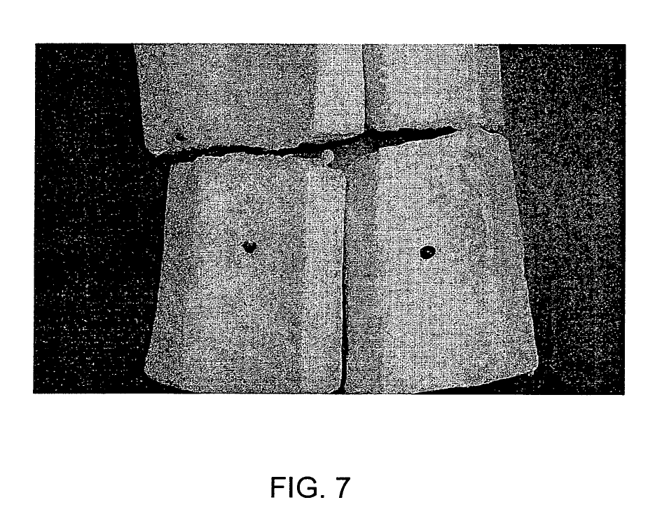

FIG. 7 illustrates the oleophobicity of the above-described bonded cellulose acetate filter elements before and after being treated with a fluorochemical finish. The bonded filter element on the left was left untreated, while the bonded filter element on the right was treated as described above. The untreated fibrous structure had a surface energy higher than the oil shown in the picture. As a result, when a drop of oil was applied to the material, the oil spread readily on the filter. Conversely, the treated fibrous structure had a surface energy lower than the oil, so the oil was repelled by the filter fibers. This forced the oil to form a discrete droplet on the fibers.

Table 1 shows the contact angles of oil on untreated and treated filter materials. In general, a contact angle larger than 90° indicates that the subject liquid does not wet out the solid substrate.

TABLE 1

| Sample | Contact Angle (Degrees) |
|---|---|
| Untreated Cellulose Acetate | 0 |
| Cellulose Acetate Treated | >110 |
| with Fluorofinish | |

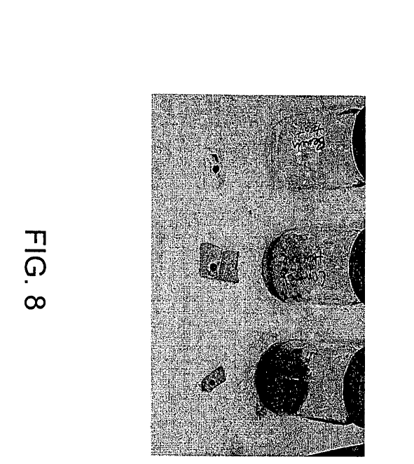

FIG. 8 illustrates the oil repellency of the above fluorochemical—treated filter elements after exposure to engine and mineral oils. After exposure to such an environment for more than 100 hours, the sample filter element on the right was washed extensively with hexane to remove oil residues. The filter element on the left was not exposed to the oil environment, but was similarly washed with hexane. Identical oil droplets were then placed on the two samples. As shown in FIG. 8, the exposed and unexposed samples exhibited the same resistance to wetting out as evidenced by the identical discrete droplets.

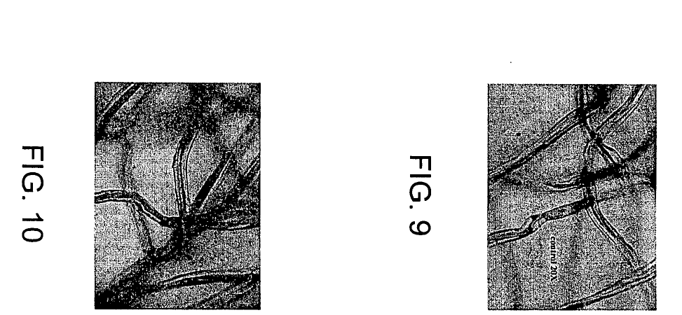

FIGS. 9 and 10 show the effects of oil exposure on fiber characteristics. FIG. 9 is a photograph of fibers in a bonded fiber control filter element that was not exposed to oil. FIG. 10 is a photograph of fibers in a bonded fiber filter element that had been exposed to oil for more than 100 hours. Both filters were formed from cellulose acetate fibers and treated with a fluorochemical as described above. A comparison of the two photographs shows that there are no signs of fiber degradation, swelling or shrinking of the oil-exposed fibers.

It will be apparent to those skilled in the art that the present invention is susceptible of a broad utility and application. Various modifications and variations can be made in the method, manufacture, configuration, and/or use of the embodiments of the invention without departing from the scope or spirit of the invention. It is to be understood, therefore, that this disclosure is not intended or to be construed to limit the present invention or otherwise to exclude any other embodiments, adaptations, variations, modifications and equivalent arrangements, the invention being limited only by the claims presented herewith.

What is claimed is:

1. A filter element for removing a liquid challenge material dispersed in a carrier fluid, the filter element comprising:
a three dimensional, self-sustaining, fluid transmissive body comprising a plurality of thermoplastic fibers bonded to each other at spaced apart points of contact, the fibers collectively defining a tortuous fluid flow path through the fluid transmissive body from a fluid inlet surface to a fluid outlet surface,
wherein at least a portion of the thermoplastic fibers comprise a surface-forming material having a surface energy that is less than a surface tension of the challenge material.

2. A filter element according to claim 1 wherein the surface-forming material comprises a fluorochemical.

3. A filter element according to claim 2 wherein the fluorochemical comprises one of the set consisting of fluoroacrylate copolymers, perfluoroacrylate copolymers, fluoroalkylacrylate copolymers, fluoroalkylmethacrylate copolymers, fluoroalkyl alcohols, fluoroalkyl esters, fluoro-substituted olefin copolymers, polyvinylidene fluoride, ethylene-chlorotrifluoroethylene copolymer, polychlorotrifluoroethylene, fluorinated ethylene propylene copolymer, perfluoroalkoxy polymers, copolymers of tetrafluoroethylene and perfluormethylvinyl ether, copolymers of tetrafluoroethylene and perfluoroalkyl vinyl ester, copolymers of tetrafluoroethylene and hexafluoropropylene, copolymers of tetrafluoroethylene and ethylene, copolymers of vinylidene fluoride and hexafluoropropylene, terpolymers of vinylidene fluoride, hexafluoropropylene and trifluoroethylene, polytrifluoroethylene, and polyhexafluoropropylene.

4. A filter element according to claim 1 wherein the surface-forming material is a coating adhered to the thermoplastic fibers.

5. A filter element according to claim 1 wherein the surface-forming material is an integral component of each fiber of the at least a portion of the thermoplastic fibers.

6. A filter element according to claim 1 wherein the at least a portion of the thermoplastic fibers include sheath-core multicomponent fibers having a sheath formed from the surface-forming material.

7. A filter element according to claim 1 wherein the fluid transmissive body is a cylinder with first and second cylinder ends connected by an outer cylindrical surface and having a cylindrical annulus through the cylinder from the first cylinder end to the second cylinder end, the cylindrical annulus defining an inner cylindrical surface.

8. A filter element according to claim 7 wherein one of the inner and outer cylindrical surfaces forms the fluid inlet surface and the other of the inner and outer cylindrical surfaces forms the fluid outlet surface.

9. A filter element according to claim 1 wherein the fluid transmissive body is a monolithic block having a first side defining the fluid inlet surface and a second side defining the fluid outlet surface.

10. A filter element according to claim 1 wherein the fluid transmissive body comprises a plurality of bonded fiber regions, at least two of the bonded fiber regions having different porosities.

11. A filter element according to claim 1 wherein the fluid transmissive body comprises a plurality of bonded fiber regions, each having a different porosity.

12. A filter element according to claim 1 wherein the fluid transmissive body comprises a first bonded fiber region having a first surface-forming material having a first surface energy that is less than the surface tension of the challenge material and a second bonded fiber region having a second surface-forming material having a second surface energy that is less than a surface tension of the challenge material, wherein the first surface energy is different from the second surface energy.

13. A filter element for removing an oil-based challenge material dispersed in a carrier fluid, the filter element comprising:
a three dimensional, self-sustaining, fluid transmissive body comprising a plurality of thermoplastic fibers bonded to each other at spaced apart points of contact, the fibers collectively defining a tortuous fluid flow path through the fluid transmissive body from a fluid inlet surface to a fluid outlet surface,
wherein at least a portion of the thermoplastic fibers are coated with a coating material having a surface energy that is less than a surface tension of the challenge material.

14. A filter element according to claim 13 wherein the coating material comprises one of the set consisting of fluoroacrylate copolymers, perfluoroacrylate copolymers, fluoroalkylacrylate copolymers, fluoroalkylmethacrylate copolymers, fluoroalkyl alcohols, fluoroalkyl esters, fluoro-substituted olefin copolymers.

15. A filter element according to claim 13 wherein the fluid transmissive body is a cylinder with first and second cylinder ends connected by an outer cylindrical surface and having a cylindrical annulus through the cylinder from the first cylinder end to the second cylinder end, the cylindrical annulus defining an inner cylindrical surface.

16. A filter element according to claim 15 wherein one of the inner and outer cylindrical surfaces forms the fluid inlet surface and the other of the inner and outer cylindrical surfaces forms the fluid outlet surface.

17. A filter element according to claim 13 wherein the fluid transmissive body is a monolithic block having a first side defining the fluid inlet surface and a second side defining the fluid outlet surface.

18. A filter element according to claim 13 wherein the fluid transmissive body comprises a plurality of bonded fiber regions, at least two of the bonded fiber regions having different porosities.

19. A filter element according to claim 13 wherein the fluid transmissive body comprises a plurality of bonded fiber regions, each having a different porosity.
